(19) United States
(12) Patent Application Publication
(10) Pub. No.: US 2025/0167444 A1
(43) Pub. Date: May 22, 2025

(54) THREE-DIMENSIONAL TRUE TIME DELAY SYSTEM

(71) Applicant: RFCORE CO.,LTD., Gyeonggi-do (KR)

(72) Inventors: Bok-Ju PARK, Chungcheongnam-do (KR); Byeong-Gyu PARK, Gyeonggi-do (KR); Sung-Young LEE, Gyeonggi-do (KR); Han-Sol PARK, Seoul (KR); Sang-Bong YOON, Gyeonggi-do (KR)

(21) Appl. No.: 18/394,501

(22) Filed: Dec. 22, 2023

(30) Foreign Application Priority Data
Nov. 22, 2023 (KR) 10-2023-0163467

(51) Int. Cl. H01Q 3/26

(52) U.S. Cl. CPC H01Q 3/2682

(57) ABSTRACT

A three-dimensional true time delay system includes: a true time delay package that includes a capacitor and an inductor to delay applied RF signals as much as a predetermined delay time; and a delay element unit three-dimensionally manufactured on a glass substrate to additionally delay the RF signals transferred from the true time delay package, wherein the delay element unit is manufactured by forming solenoid-shaped via holes in the glass substrate and filling the solenoid-shaped via hole with a conductor.

### BACKGROUND

The present invention relates to a three-dimensional true time delay system using a glass substrate, and more specifically, to a three-dimensional true time delay system that can increase the quality factor while being implemented in a smaller area by three-dimensionally forming passive elements on a glass substrate.

In an antenna system employing multiple phase array antennas, a phase required for beam steering is set for each of the multiple phased array antennas.

However, when the antenna system employing the phase array antennas using a phase shifter described above is driven in a frequency band having a wide instantaneous bandwidth, such as millimeter wave 5G communication, a problem of seriously shifting the beam of steered RF signals may occur at the frequencies other than the frequency that sets the beam steering. For example, the instantaneous bandwidth of some millimeter wave 5G communication methods reaches up to 800 MHz on the basis of 28 GHz signals. That is, the 5G communication method with a center frequency of 28 GHz may operate between 27.6 GHZ and 28.4 GHZ, and in this case, when the beam is set to be steered in a specific direction at 28 GHz, a beam shift phenomenon occurs at 27.6 GHz or 28.4 GHz, and the beam is steered in a direction other than the set direction.

Although a True Time Delay (TTD) device is employed to adjust the delay time of each of the multiple phase array antennas in order to solve the disadvantages described above, there is a problem in that when the number of phase array antennas increases, the area of the true time delay device increases, and the quality factor of the true time delay device decreases.

The background technology of the present invention is disclosed in Korean Patent Publication No. 10-2045498.

### SUMMARY OF THE INVENTION

Therefore, the present invention has been made in view of the above problems, and it is an object of the present invention to provide a three-dimensional true time delay system that can increase the quality factor while being implemented in a smaller area by three-dimensionally forming passive elements on a glass substrate.

The technical problems to be solved by the present invention are not limited to the technical problems mentioned above, and unmentioned other technical problems will be clearly understood by those skilled in the art from the following description.

To accomplish the above object, according to one aspect of the present invention, there is provided a three-dimensional true time delay system comprising: a true time delay package that includes a capacitor and an inductor to delay applied RF signals as much as a predetermined delay time; and a delay element unit three-dimensionally manufactured on a glass substrate to additionally delay the RF signals transferred from the true time delay package, wherein the delay element unit may be manufactured by forming solenoid-shaped via holes in the glass substrate and filling the solenoid-shaped via hole with a conductor.

In the three-dimensional true time delay system according to an embodiment of the present invention, the delay element unit may be manufactured by forming via holes in parallel on the top surface of the glass substrate, forming via holes in parallel on the bottom surface of the glass substrate, forming via holes penetrating the glass substrate so that the upper via holes of the glass substrate and the lower via holes of the glass substrate penetrate each other, and filling the via holes with a conductor.

In the three-dimensional true time delay system according to an embodiment of the present invention, a spacer unit formed by forming via holes in a separate glass substrate and filling the via holes with a conductor may be disposed between the true time delay package and the delay element unit to be connected to the conductor of the delay element unit.

In the three-dimensional true time delay system according to an embodiment of the present invention, thickness H of the spacer unit may be 1 to 5 times the width W of the conductor of the delay element unit.

In the three-dimensional true time delay system according to an embodiment of the present invention, the spacer unit is disposed in plurality between the true time delay package and the delay element unit.

In the three-dimensional true time delay system according to an embodiment of the present invention, a high resistivity layer for suppressing eddy current that may be induced when the inductor is delayed in the delay element unit may be disposed between the true time delay package and the spacer unit.

In the three-dimensional true time delay system according to an embodiment of the present invention, the high resistivity layer may be formed by doping B, P, or As on a silicon substrate through an ion implantation process.

To accomplish the above object, according to another aspect of the present invention, there is provided a three-dimensional true time delay system comprising: a true time delay package that includes a capacitor and an inductor to delay applied RF signals as much as a predetermined delay time; and a delay element unit three-dimensionally manufactured on a plurality of stacked glass substrates to additionally delay the RF signals transferred from the true time delay package, wherein the delay element unit may be manufactured by forming solenoid-shaped via holes in the plurality of stacked glass substrates and filling the solenoid-shaped via hole with a conductor.

In the three-dimensional true time delay system according to another embodiment of the present invention, the delay element unit may include: an upper layer unit in which via holes are formed in parallel on the top surface of the uppermost glass substrate among the plurality of stacked glass substrates, and the via holes are filled with a conductor; a lower layer unit in which via holes are formed in parallel on the bottom surface of the lowermost glass substrate among the plurality of stacked glass substrates, and the via holes are filled with a conductor; and a middle layer unit in which via holes are formed in a middle glass substrate between the upper glass substrate and the lower glass substrate to penetrate the via holes of the upper glass substrate and the via holes of the lower glass substrate, and the via holes are filled with a conductor.

In the three-dimensional true time delay system according to another embodiment of the present invention, the middle layer unit of the delay element unit may be included in plurality.

In the three-dimensional true time delay system according to another embodiment of the present invention, a spacer unit formed by forming via holes in a separate glass substrate and filling the via holes with a conductor may be disposed between the true time delay package and the delay element unit to be connected to the conductor of the delay element unit.

In the three-dimensional true time delay system according to another embodiment of the present invention, thickness H of the spacer unit may be 1 to 5 times the width W of the conductor of the delay element unit.

In the three-dimensional true time delay system according to another embodiment of the present invention, the spacer unit may be disposed in plurality between the true time delay package and the delay element unit.

In the three-dimensional true time delay system according to another embodiment of the present invention, a high resistivity layer for suppressing eddy current that may be induced when the inductor may be delayed in the delay element unit may be disposed between the true time delay package and the spacer unit.

In the three-dimensional true time delay system according to another embodiment of the present invention, the high resistivity layer may be formed by doping B, P, or As on a silicon substrate through an ion implantation process.

### BRIEF DESCRIPTION OF THE DRAWINGS

FIG. 1 is a perspective view showing a three-dimensional true time delay system using a glass substrate according to embodiments of the present invention.

FIG. 2 is a perspective view showing a delay element unit employed in a three-dimensional true time delay system using a glass substrate according to embodiments of the present invention.

FIG. 3 is a perspective view showing a true time delay package employed in a three-dimensional true time delay system using a glass substrate according to embodiments of the present invention.

FIG. 4 is a perspective view showing a spacer unit employed in a three-dimensional true time delay system using a glass substrate according to embodiments of the present invention.

FIG. 5 is a cross-sectional view of FIG. 1.

FIG. 6 is a front view of FIG. 1.

FIG. 7 is a side view of FIG. 1.

FIG. 8 is a plan view of FIG. 1.

FIG. 9 is a bottom view of FIG. 1.

### DETAILED DESCRIPTION OF THE PREFERRED EMBODIMENT

The detailed description of the present invention described below refers to the accompanying drawings, which show, by way of example, specific embodiments in which the present invention may be practiced. These embodiments are described in sufficient detail to allow those skilled in the art to practice the present invention. It should be understood that the various embodiments of the present invention are different from one another but are not necessarily mutually exclusive.

For example, it should be understood that specific shapes, structures and characteristics described herein may be implemented in other embodiments in connection with one embodiment without departing from the principles of the present invention, and the location or arrangement of individual components within each disclosed embodiment may be changed without departing from the principles of the present invention.

Accordingly, the detailed description described below is not intended to be taken in a limiting sense, and the scope of the present invention is limited only by the appended claims, together with all equivalents to what the claims assert, when it is properly described.

Similar reference numerals in the drawings refer to identical or similar functions throughout several aspects, and the length, area, thickness, or the like may be exaggerated for convenience.

Additionally, when a part “includes” a certain component, this means that it may further include other components, rather than excluding other components, unless specifically stated otherwise.

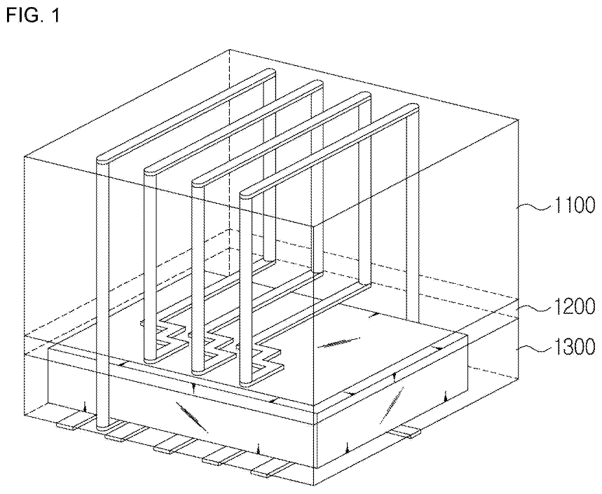

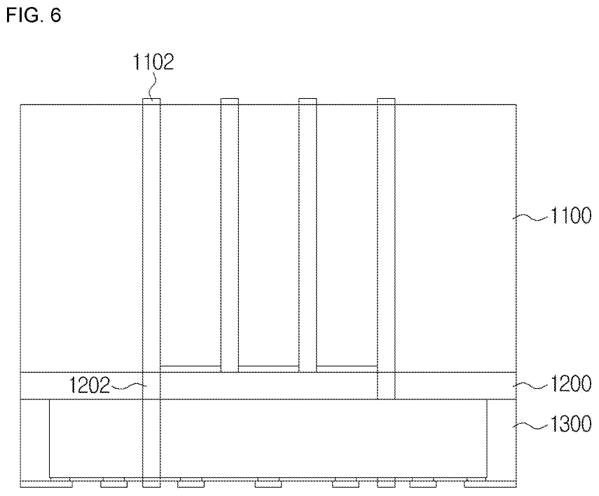

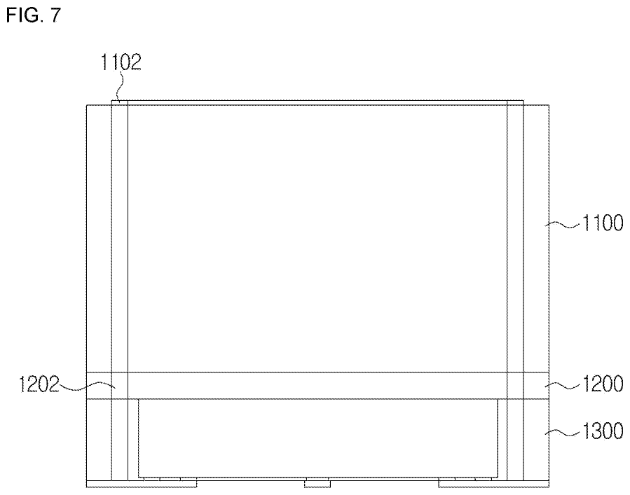

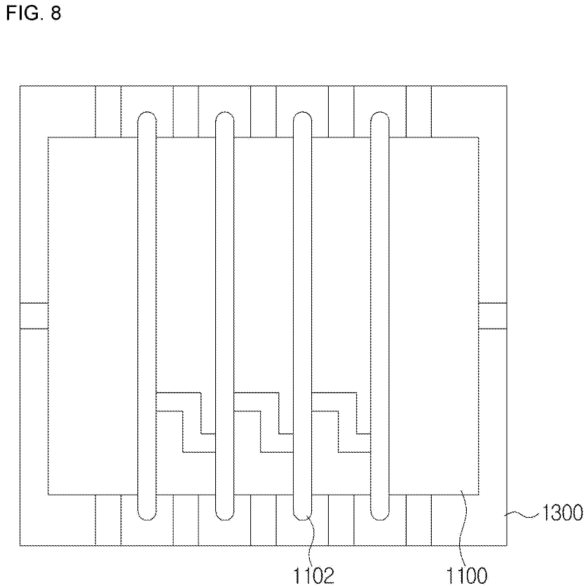

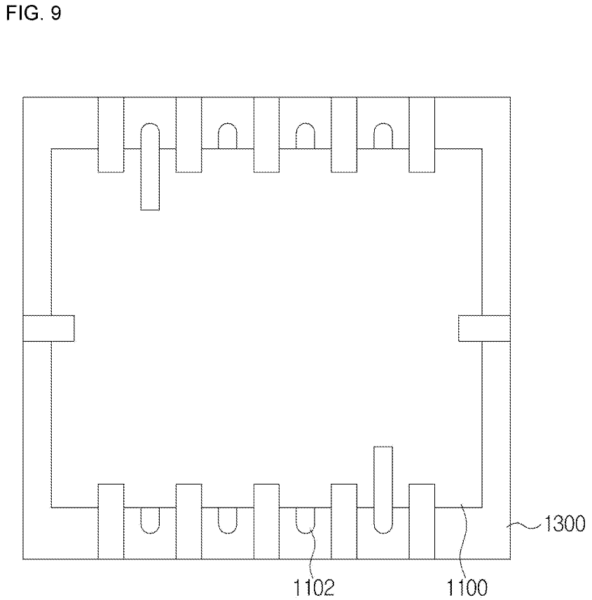

As shown in FIGS. 1 to 9, a three-dimensional true time delay system according to an embodiment of the present invention includes a true time delay package 1300 that includes a capacitor and an inductor to delay applied RF signals as much as a predetermined delay time, and a delay element unit 1100 three-dimensionally manufactured on a glass substrate 1101 to additionally delay the RF signals transferred from the true time delay package 1300.

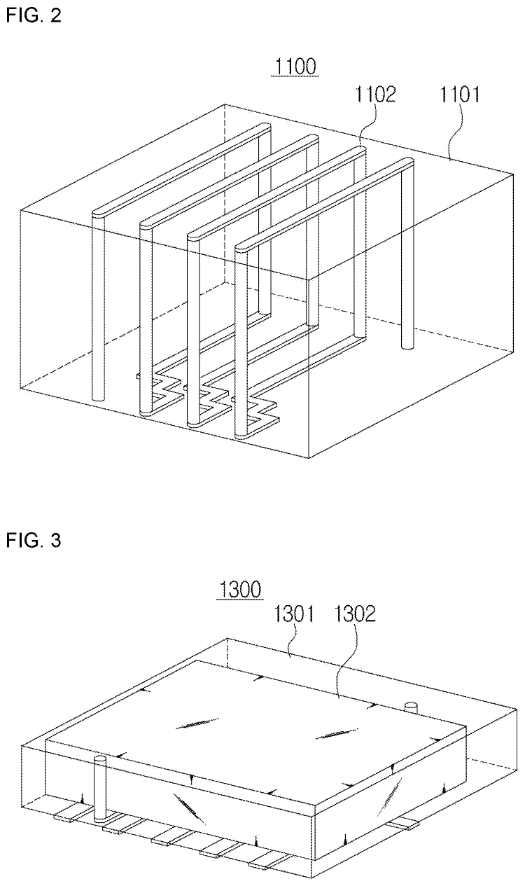

Here, as shown in FIG. 2, the delay element unit 1100 is manufactured by forming solenoid-shaped via holes in the glass substrate 1101 and filling the solenoid-shaped via hole with a conductor 1102 such as copper.

Specifically, as shown in FIG. 2, the delay element unit 1100 is manufactured by forming via holes in parallel on the top surface of the glass substrate 1101, forming via holes in parallel on the bottom surface of the glass substrate 1101, forming via holes penetrating the glass substrate 1101 so that the upper via holes of the glass substrate 1101 and the lower via holes of the glass substrate 1101 penetrate each other, and filling the via holes with a conductor 1102.

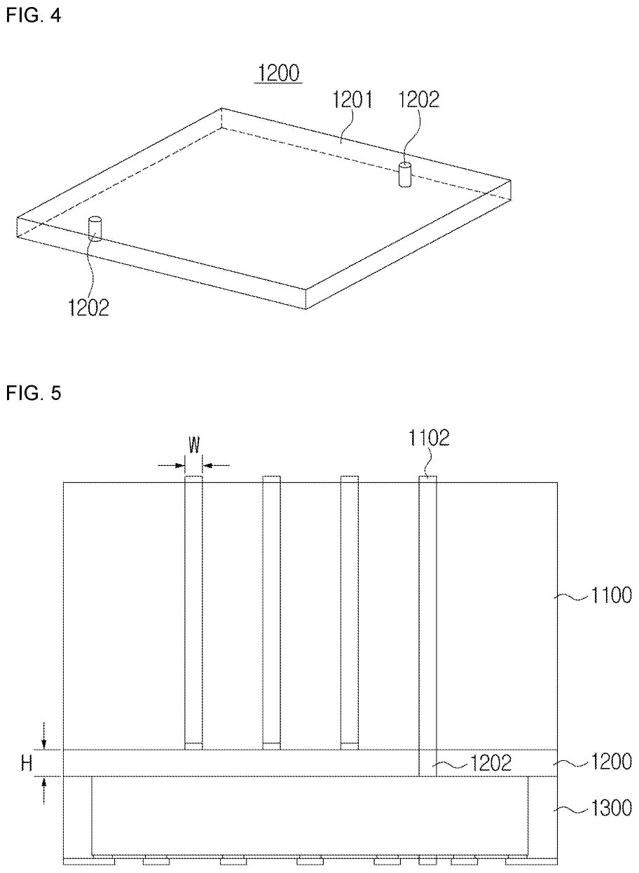

Meanwhile, as shown in FIG. 4, a spacer unit 1200 formed by forming via holes in a separate glass substrate 1201 and filling the via holes with a conductor 1202 is disposed between the true time delay package 1300 and the delay element unit 1100 to be connected to the conductor 1102 of the delay element unit 1100. The spacer unit 1200 may increase the magnitude of the inductance of the delay element unit 1100, and may be disposed in plurality as needed. Here, the thickness H of the spacer unit 1200 is approximately 1 to 5 times the width W of the conductor 1102 of the delay element unit 1100.

In addition, a high resistivity layer for suppressing eddy current that may be induced when the inductor is delayed in the delay element unit 1100 is disposed between the true time delay package 1300 and the spacer unit 1200.

Specifically, the high resistivity layer may be formed by doping B, P, or As on a silicon substrate through an ion implantation process.

Hereinafter, a three-dimensional true time delay system according to another embodiment of the present invention will be described, and the difference from the three-dimensional true time delay system according to an embodiment of the present invention will be described.

The delay element unit 1100 of a three-dimensional true time delay system according to another embodiment of the present invention is formed by forming solenoid-shaped via holes in a plurality of stacked glass substrates and filling the solenoid-shaped via holes with a conductor 1102.

Here, the delay element unit 1100 includes an upper layer unit in which via holes are formed in parallel on the top surface of the uppermost glass substrate among the plurality of stacked glass substrates, and the via holes are filled with a conductor 1102, a lower layer unit in which via holes are formed in parallel on the bottom surface of the lowermost glass substrate among the plurality of stacked glass substrates, and the via holes are filled with a conductor 1102, and a middle layer unit in which via holes are formed in a middle glass substrate between the upper glass substrate and the lower glass substrate to penetrate the via holes of the upper glass substrate and the via holes of the lower glass substrate, and the via holes are filled with a conductor 1102.

Meanwhile, the middle layer unit of the delay element unit 1100 may be included in plurality as needed so that the magnitude of the inductance of the delay element unit 1100 can be adjusted.

The three-dimensional true time delay systems according to the embodiments of the present invention may increase the quality factor while being implemented in a smaller area by three-dimensionally forming passive elements on a glass substrate.

Although the present invention has been described and illustrated in connection with preferred embodiments for illustrating the principles of the present invention, the present invention is not limited to the configuration and operation as shown and described above.

Rather, those skilled in the art will understand that many changes and modifications can be made to the present invention without departing from the spirit and scope of the appended claims.

Accordingly, all such appropriate changes, modifications, and equivalents should be considered to fall within the scope of the present invention.

What is claimed is:

1. A three-dimensional true time delay system comprising:
a true time delay package that includes a capacitor and an inductor to delay applied RF signals as much as a predetermined delay time; and
a delay element unit three-dimensionally manufactured on a glass substrate to additionally delay the RF signals transferred from the true time delay package, wherein
the delay element unit is manufactured by forming solenoid-shaped via holes in the glass substrate and filling the solenoid-shaped via hole with a conductor.

2. The system according to claim 1, wherein the delay element unit is manufactured by forming via holes in parallel on the top surface of the glass substrate, forming via holes in parallel on the bottom surface of the glass substrate, forming via holes penetrating the glass substrate so that the upper via holes of the glass substrate and the lower via holes of the glass substrate penetrate each other, and filling the via holes with a conductor.

3. The system according to claim 2, wherein a spacer unit formed by forming via holes in a separate glass substrate and filling the via holes with a conductor is disposed between the true time delay package and the delay element unit to be connected to the conductor of the delay element unit.

4. The system according to claim 3, wherein thickness H of the spacer unit is 1 to 5 times the width W of the conductor of the delay element unit.

5. The system according to claim 3, wherein the spacer unit is disposed in plurality between the true time delay package and the delay element unit.

6. The system according to claim 3, wherein a high resistivity layer for suppressing eddy current that may be induced when the inductor is delayed in the delay element unit is disposed between the true time delay package and the spacer unit.

7. The system according to claim 6, wherein the high resistivity layer is formed by doping B, P, or As on a silicon substrate through an ion implantation process.

8. A three-dimensional true time delay system comprising:
a true time delay package that includes a capacitor and an inductor to delay applied RF signals as much as a predetermined delay time; and
a delay element unit three-dimensionally manufactured on a plurality of stacked glass substrates to additionally delay the RF signals transferred from the true time delay package, wherein
the delay element unit is manufactured by forming solenoid-shaped via holes in the plurality of stacked glass substrates and filling the solenoid-shaped via hole with a conductor.

9. The system according to claim 8, wherein the delay element unit includes:
an upper layer unit in which via holes are formed in parallel on the top surface of the uppermost glass substrate among the plurality of stacked glass substrates, and the via holes are filled with a conductor;
a lower layer unit in which via holes are formed in parallel on the bottom surface of the lowermost glass substrate among the plurality of stacked glass substrates, and the via holes are filled with a conductor; and
a middle layer unit in which via holes are formed in a middle glass substrate between the upper glass substrate and the lower glass substrate to penetrate the via holes of the upper glass substrate and the via holes of the lower glass substrate, and the via holes are filled with a conductor.

10. The system according to claim 9, wherein the middle layer unit of the delay element unit is included in plurality.

11. The system according to claim 9, wherein a spacer unit formed by forming via holes in a separate glass substrate and filling the via holes with a conductor is disposed between the true time delay package and the delay element unit to be connected to the conductor of the delay element unit.

12. The system according to claim 11, wherein thickness H of the spacer unit is 1 to 5 times the width W of the conductor of the delay element unit.

13. The system according to claim 11, wherein the spacer unit is disposed in plurality between the true time delay package and the delay element unit.

14. The system according to claim 11, wherein a high resistivity layer for suppressing eddy current that may be induced when the inductor is delayed in the delay element unit is disposed between the true time delay package and the spacer unit.

15. The system according to claim 14, wherein the high resistivity layer is formed by doping B, P, or As on a silicon substrate through an ion implantation process.
